(19) United States
(12) Patent Application Publication
(10) Pub. No.: US 2006/0061822 A1
(43) Pub. Date: Mar. 23, 2006

(54) Method and device for temporarily storing image data

(76) Inventors: Chih-Ta Star Sung, Glonn (DE); Yin Chun Lan, Wurih Township (TW)

Correspondence Address: Chih-Ta Star Sung;RM. 308, BLD. 52, NO. 195, CHUNG HSING RD., SEC. 4, CHU TUNG TOWNSHIP, HSINCHU COUNTY, 310, TW

(21) Appl. No.: 10/946,088

(22) Filed: Sep. 22, 2004

(51) Int. Cl. G06K 15/00

(52) U.S. Cl. 358/1.16

(57) ABSTRACT

The present invention provides method and apparatus of image data compression for the temporary image storage buffer. At least one image pixel is compressed and stored in a storage device for the following pixel's reference. The difference planes among R-plane, G-plane, and B-plane are generated to take advantage of correlation among color components in reducing the image data. The difference between adjacent pixels is generated to further reduce the length of the code of image pixels.

### BACKGROUND

1. Field

The present invention relates to a method and device for temporarily storing data, and more particularly relates to a method and device for providing a temporary buffer for storing image data.

2. Description of Related Art

Digital image and motion video have been adopted in an increasing number of applications, which include digital camera, scanner/printer/fax machine, video telephony, videoconferencing, surveillance system, VCD (Video CD), DVD, digital TV including LCD TV and PDP TV. A reconstructed image either decoded from a compressed still image (like a JPEG picture) or from a motion video is saved in a temporary image buffer before the reconstructed image is output to another media or device. Due to the advantage of sharp image quality, the LCD (Liquid Crystal Display) panel has been prevailingly accepted by consumers electronic industry since ten years ago starting in the applications of notebook PC. Applications of LCD display include desk top PCs, Notebook PCs, PDAs, mobile phones, digital TVs, LCD TVs, etc.

In a Multi-Function Peripheral or Printer (MFP), a scanned image is saved in a temporary image buffer for a certain of time before the scanned image is printed or sent out to a destination. In other words, image related displays and scanning/printing products usually require high density of memory for providing temporary image storage.

FIG. 1 illustrates an example of image processing applications of prior art. In most image and video applications, from the image display point of view, a reconstructed image is temporarily stored in an image buffer before it is displayed. Taking the LCD display sub-system as an example, the reconstructed picture which might come from an MPEG movie or an JPEG picture decoder 11 is temporarily saved in an image buffer 16. A display controller and scaler 12 control the image data input/output and re-sizes the image according to the predetermined display picture size and to fit the size and aspect ratio of the LCD display panel 14. An LCD driver 13 drives the LCD “lights” according to the instruction from the LCD controller/scaler.

In the MFP application, the scanned image is also temporarily saved in an image buffer 16 before being printed. Most MFPs have higher than 600 dpi (dot per inch) resolutions which are equivalent to six time higher resolution in X-axis and Y-axis, a total of 36 times more pixels per inch compared to an LCD display which has about 100 pixels per inch. In the application of a Digital TV, DTV, a re-constructed MPEG 2 movie with 60 frame per second display rate with a popular 31 inches display needs at least to store 3 frames into an image buffer for scaling, de-interlacing and temporary will requires. An MPEG 2 movie with 3 pictures of 720×480 resolution requires at least 3×24×(720×480)˜25M bits of memory density to store the pixels. In some designs, the scaled pictures are stored into a temporary image buffer waiting for the right timing to display. In the image or video compression point of view, no matter in R,G,B or in Y, U,V format, the raw image data are stored in a temporary image buffer which is mostly a DRAM memory. Taking a 3 million pixels digital camera as an example, it requires a total of 9.0 million bytes of density of memory to store the raw data before sending them into an image or video compression engine. All above applications requires very higher memory density and cost to store the image raw data. Therefore, it would be very beneficial to overcome the high density and hence high cost of the memory chip and high IO bandwidth requirements for the image display or output buffer by compressing the image which is supposed to be stored in the temporary image buffer. It would be also beneficial to save power dissipation during the transferring between an off-chip memory and the display or output device controller.

### SUMMARY OF THE INVENTION

The present invention is related to a method and device for temporarily buffering image data from a first device to a second device. Particularly, the present invention relates to compressing the image data of the temporary buffer before being sent to the compression engine or to the display engine. The present invention significantly reduces the required density of the storage device for temporarily saving the image before display.

The present invention of the image compression reduces the redundant data among Red, Green and Blue or Y, U, V or Y, Cb, Cr components before storing them into the image buffer for the image output.

The present invention of the image compression reduces the redundant data among Red, Green and Blue or Y, U, V or Y, Cb, Cr components before sending the raw image data to the compression engine.

According to an embodiment of this invention of the present invention of the image compression, an image is separately compressed by dividing into three color components.

According to an embodiment of this invention of the present invention of the image compression, a “DPCM, Differential Pulse Coded Modulation” algorithm is applied to reduce the data amount between adjacent pixels to achieve higher compression rate.

According to an embodiment of this invention of the present invention of the image compression, a method of an “Adaptive variable length coding” is adopted to reduce the code length of each color component difference.

According to an embodiment of this invention of the present invention of the image compression, the image of a picture is divided into a certain amount of “GOP, Group of Pixels” with a certain amount of pixels as a compression unit to achieve higher compression rate.

According to an embodiment of this invention of the present invention of the image compression, an image can be separated to be Y (Luminance), Cb and Cr and compress separately.

According to an embodiment of this invention of the present invention, when the predetermined compression rate is not achievable, a process of quantization will be applied to reduce data while still maintaining reasonable good image quality.

According to an embodiment of this invention of the present invention of the image compression, a VLC, Variable Length Coding algorithm is applied to compress the events with higher than a predetermined probability.

According to an embodiment of this invention of the present invention of the image compression, another VLC coding algorithm is applied to compress the events with probability beyond a predetermined value.

According to an embodiment of this invention of the present invention of the image compression, a quality and compression rate trade off mechanism is applied to achieve higher compression rate with the cost of sacrificing the image quality.

It is to be understood that both the foregoing general description and the following detailed description are by examples, and are intended to provide further explanation of the invention as claimed.

### BRIEF DESCRIPTION OF THE DRAWINGS

FIG. 1 illustrates an image processing apparatus of prior art;

FIG. 2A illustrates an environment in which an embodiment of the present invention is implemented therein;

FIG. 2B illustrates a systematic diagram of the embodiment according to the present invention;

FIG. 3 illustrates a flow chart of the embodiment according to the present invention;

FIG. 4 illustrates a flow chart of calculating difference information;

FIG. 5 illustrates schematic color planes in an optical device;

FIG. 6A illustrates a method of calculating offset-planes;

FIG. 6B illustrates a method of calculating adj-offset-values;

FIG. 7 illustrates a method of variable length coding;

FIG. 8 illustrates Huffman's coding;

FIG. 9 illustrates a hybrid coding of Huffman coding and Golomb-Rice coding;

FIG. 10A illustrates an exemplary implementation of the embodiment;

FIG. 10B illustrates another exemplary implementation of the embodiment;

FIG. 11 is a schematic diagram illustrating a portion of circuits in FIG. 10A and FIG. 10B; and

FIG. 12 is a detail diagram illustrating how to implement the example of FIG. 11 to a real circuit.

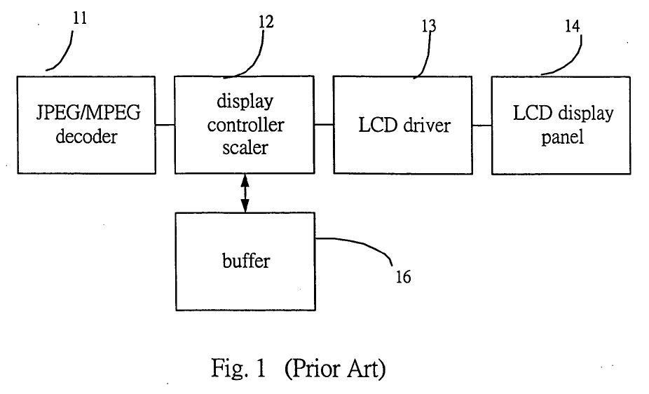

### DESCRIPTION OF THE PREFERRED EMBODIMENTS

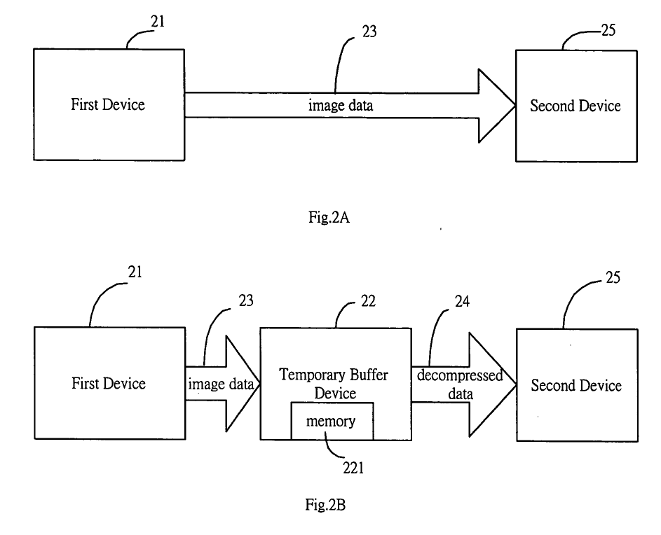

FIG. 2A illustrates an environment where an embodiment according to the present invention can be implemented therein. Image data 23 containing raw pixel information are transmitted from a first device 21 to a second device 25 for further processing. Such environment can be found in many image applications, e.g. printers, scanners, digital cameras, motion picture cameras, etc. Taking the digital camera application for an example, the first device 21 represents a raw image capturing mechanism, and the second device 25 represent a JPEG compressor for compressing raw images into JPEG files to be stored in memory cards. Taking the LCD application for another example, the first device 21 represents a scaler that transforms external TV signals to fit a certain resolution of a LCD panel, and the second device 25 represents a LCD panel and a driver circuit thereof. In prior art, for both the digital camera and the LCD applications mentioned above, a large size buffer is necessary before the second device 25 is ready to process the image data.

FIG. 2B illustrates an embodiment according to the present invention to be applied in the environment of FIG. 2A. The image data 23 are transmitted from the first device 21 and then received by a temporary buffer device 22. The temporary buffer device 22 compresses the image data and stores the compressed image data in a memory 221. When the second device 25 is ready to process the image data 23, decompressed data 24 are transmitted to the second device 25. If the compression utilized in the temporary buffer device 22 is loseless, then the decompressed data equal to the original image data 23. However, under other considerations, the decompressed data 24 are only similar, but not 100% identical to the original image data 23 if optional techniques are adopted for reducing the size of the memory 221.

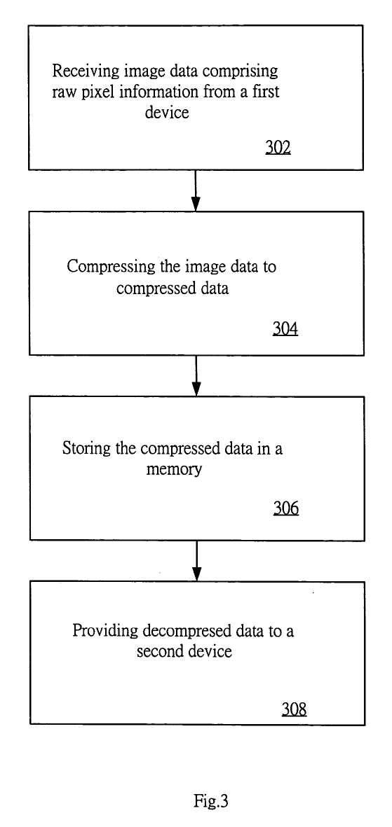

FIG. 3 is a flowchart for illustrating a method for temporarily buffering the image data 23 when the image data 23 are transmitted from the first device 21 to the second device 25.

First, the image data 23 containing raw pixel information are received (step 302). The received image data 23 are then compressed to compressed data (step 304) to be saved in the memory 221 (step 306). When the second device 25 needs the image data 23, the compressed data are decompressed and the decompressed data are sent to the second device 25 (step 308).

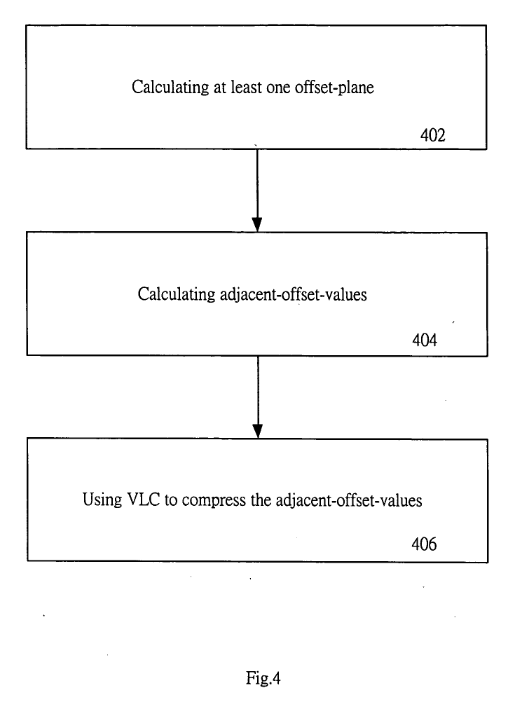

FIG. 4 illustrates a preferred example for compressing the image data 23 that contain raw pixel information in the embodiment of FIG. 2 and FIG. 3. Basically, there are three steps for compressing the image data 23. The first step is to calculate at least one offset-plane (step 402), the second step is to calculate adjacent-offset-values (step 404), and the third step is to adopt variable length coding (VLC) to compress the adjacent-offset-values (step 406). The three steps are explained as follows.

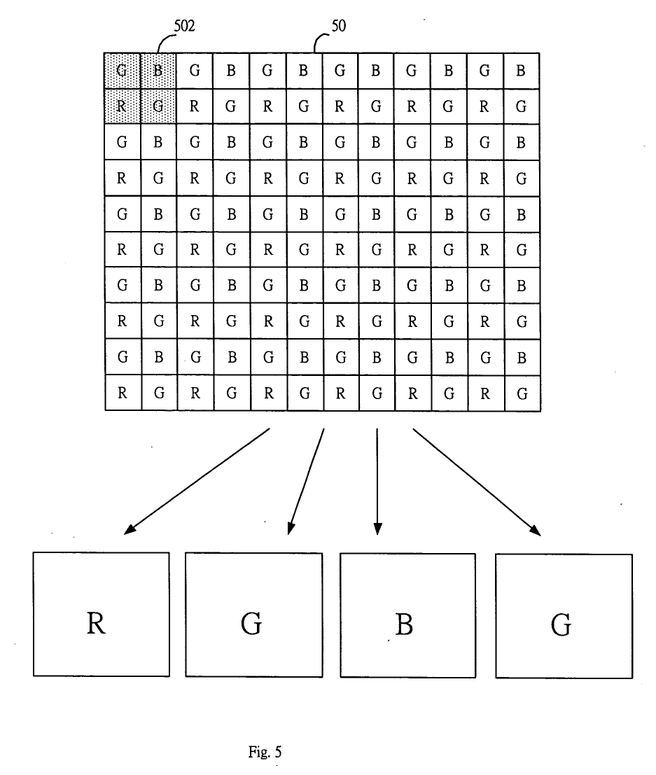

FIG. 5 illustrates a typical pixel arrangement of a CCD sensor 50 for capturing images. The CCD sensor 50 is composed of an matrix of pixels. To obtain different color information, a group of pixels 502 of CCD are respectively used for capturing R(ed), G(reen), B(lue), G(reen) information of an effective pixel. Usually, tiny optical filters are applied on the group of pixels 502 so that each of the group of CCD pixels acquires different color information. In other words, the raw pixel information of the image data 23 obtained by a CCD sensor 50, i.e. the first device 21, contain R plane, G plane, B plane and G plane color information.

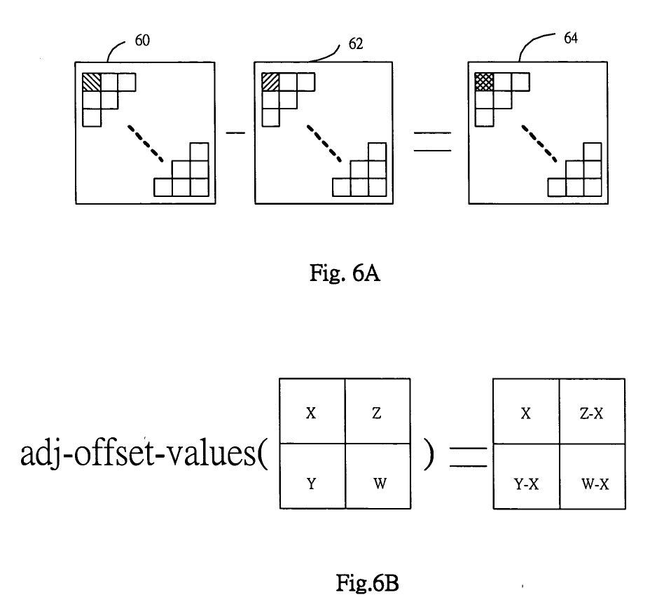

FIG. 6A illustrates an example of calculating offset-plane. The term offset-plane used here represents difference information between two pixel planes. For example, the R plane 60 and G plane 62 each composes a matrix of integers that represent Red and Green values, respectively. An offset matrix, named as Diff-RG 64, is obtained by performing a subtraction between the two matrixes of integers of the R plane 60 and the G plane 62.

The Diff-RG 64 contains difference information between the R plane 60 and the G plane 62, and therefore is an example of the offset-plane. In most multimedia applications, there is high correlation among color components. In other words, a higher compression ratio is obtained by compressing the offset-plane instead of compressing color planes directly.

Meanwhile, the offset-plane operation is reversible, illustrated in the following reversible equations.
(R-plane)−(G-plane)=(Diff-RG plane)
(R plane)−(Diff-RG)=(G plane)
In other words, smaller memory size is necessary for storing compressed G plane, Diff-RG, and Diff-BG (offset-plane of B plane and G plane) comparing with storing compressed G plane, B plane and R plane directly. At the same time, only simple operation is necessary to obtain the original image data 23 even transforming the original image data 23 to corresponding offset-planes.

FIG. 6B illustrates an example of calculating adj-offset-values. Under this exemplary function of adj-offset-values, four adjacent pixels having pixel values of x, y, z, w are transformed to x, (z-x), (y-x), (w-x), respectively. It is apparent that the example function is reversible, too.

Other similar functions can be used to calculate difference information among adjacent pixels. The term adj-offset-values used here represents difference information among adjacent pixels. In most multimedia applications, an image is usually composed of a plurality of shapes, each representing some object having same color. Therefore, adjacent pixels usually have certain level of resemblance, which brings higher compression ratio. In other words, the offset-planes mentioned above can be further compressed by calculating their adj-offset-values.

Theoretically, the sequence of calculations for the offset-planes and the adj-offset-values can be interchanged. In other words, it is possible to choose calculating the offset-planes first or the adj-offset-values first, or only calculating either the offset-planes or the adj-offset-values.

Additionally, in case of application requiring even higher compression beyond a certain degree of the lossless compression, a quantization mechanism is enforced to filter out some non-critical information and reduce the amount of code. During the procedure of quantization, the difference of the adjacent pixels of the offset-planes is divided by a predetermined value said 2, 4 or other numbers. When divided-by-2² is selected, only right shifting is needed which is simple and fast.

Quantization causes more or less degradation of image quality. In the practical cases, the quantization step will not cause much quality degradation since the number of the data to be quantized is the difference of adjacent pixels of the color differential plane. The effect of error caused by quantization will be diluted when it is recovered in the process of decompression. A multiplexer can be used for selecting whether the difference of adjacent pixels is from an output of the quantization engine or directly from the offset-plane through the subtraction.

After calculating the offset-planes and/or adj-offset-values, data to be compressed have higher correlation, which guarantee higher compression ratios. Variable length coding (VLC) method is utilized here for an example for compressing the data.

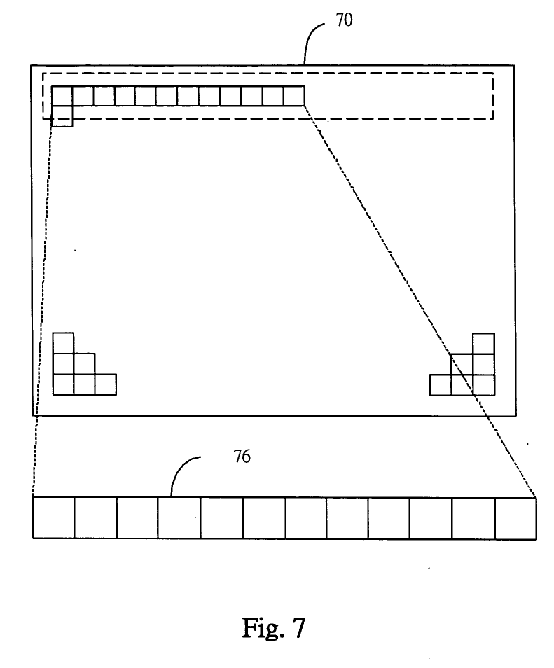

FIG. 7 illustrates a matrix of adj-offset-values for one offset-plane 70. In this example, a certain amount of pixels or a GOP (group of pixels) are selected as a compression unit. For instance, the GOP 76 of twelve pixels is regarded as a compression unit 76. The individual value of a GOP 76 can be coded separately by a VLC, like the Golomb-Rice coding or the Huffman coding or a combinational coding approach of Golomb-Rice and Huffman coding. In this example, a combinational approach is applied to reduce the code size of the difference plane of the adjacent pixels.

Particularly, continuous “0s” till the end of a GOP can be coded as “EOB, End Of Block” 78 for which a short code, for instance “00” is assigned to represent it.

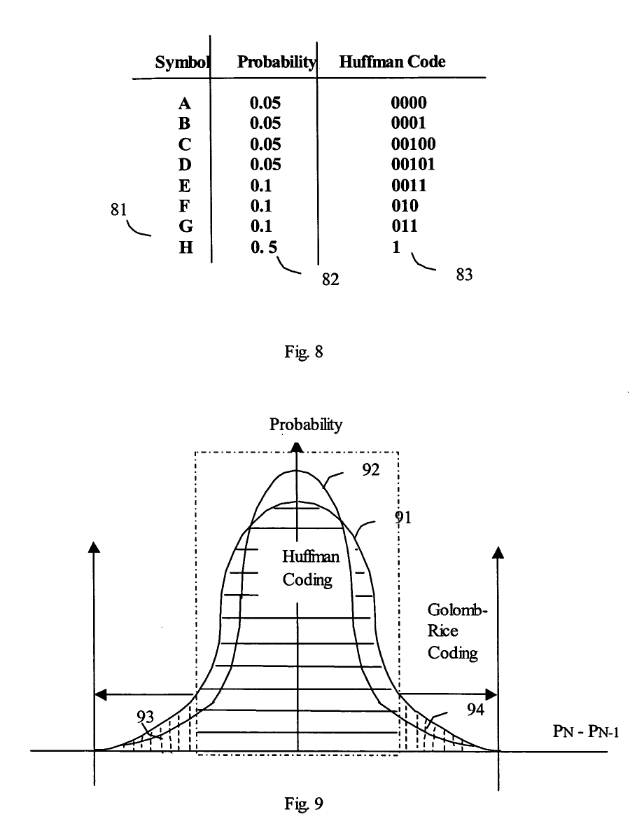

The Huffman coding is one of the most popular VLC coding which uses smallest code to represent the most frequent happened pattern as shown in the FIG. 8. The 1st column 81 shows the events/patterns, the 2nd column lists the probability of each event. According to the probability of the event, the 3rd column shows the Huffman code for each of the event. It is obvious that the higher the probability, the shorter code can be assigned to represent it.

FIG. 9 depicts the probability of the differential values of the adj-offset-values. A certain range 91 of the adj-offset-values, e.g. +/−4, are coded by the Huffman coding technique. Beyond this range, the adj-offset-values 93, 94 are coded by a so named “Golomb-Rice” technique.

A Golomb-Rice coding is to code the “remainder”, a “K” of the 2K representing M, the divider and the “Quotient” as shown in the following equation:
V=Q×M+R (Q: Quotient and R: Remainder)

If a lossy compression is applied to eliminate some predetermined smaller values, the probability distribution can be even more concentrated 92 with higher probability in the “0” difference. In principle, the higher the probability of “0” the shorter the code can be assigned to represent it and the higher the compression rate can be achieved.

The above descriptions have explained the embodiment in the method aspect, including three steps, i.e. calculating offset-planes, calculating adj-offset-values, and compressing the adj-offset-values. Next, examples are provided for further explaining how to implement such method in image processing circuits.

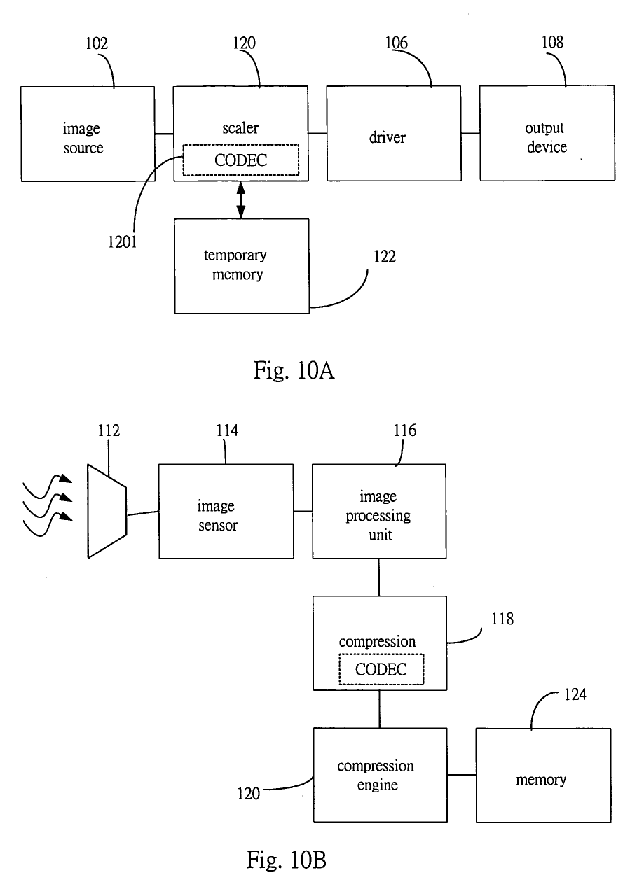

FIG. 10A illustrates a first example of using the above embodiment. This example can be applied in LCD/CRT displays, Multifunctional Peripherals (MFP), Printers etc. An image source 102, e.g. an MPEG/JPEG decoder, provides images to a scaler 120, which adjusts resolutions of the images to fit the resolution of an output device 108, like LCD display, printer.

When the scaler 120 finishes its work, the image data need to be stored temporarily before they are transmitted to a driver 106 for outputting on the output device 108. The embodiment is implemented as a Coder/Decoder 1201(CODEC) for performing the three steps mentioned above to compress/decompress the image data form/to a temporary memory 122 to reduce the temporary memory necessary to buffer the image data.

FIG. 10B illustrates a second example of using the above embodiment. This example can be applied in still image cameras, motion picture recorders, scanners, etc. Images are captured by an image sensor 114 through a lens 112. Examples of image sensor 114 include Charge Coupled Devices (CCDs), CMOS image sensors, etc. The captured raw image data is then delivered to a image processing unit 116 which includes functions like gamma correction, color compensation and interpolation. The image pixels after the image processing unit 116 are processed by a compression engine 118 and then stored temporarily before they are sent to another image compression engine 120 for data reduction so that smaller size files are available for storing in a flash memory 124 or other recording medium or being transmitted via a network. A CODEC 118 that performs the three steps mentioned above is coupled between the image processing unit 116 and the image compression engine 120 to provide a temporary buffer of the image data, while the CODEC 118 only needs much less memory size and consumes much less power.

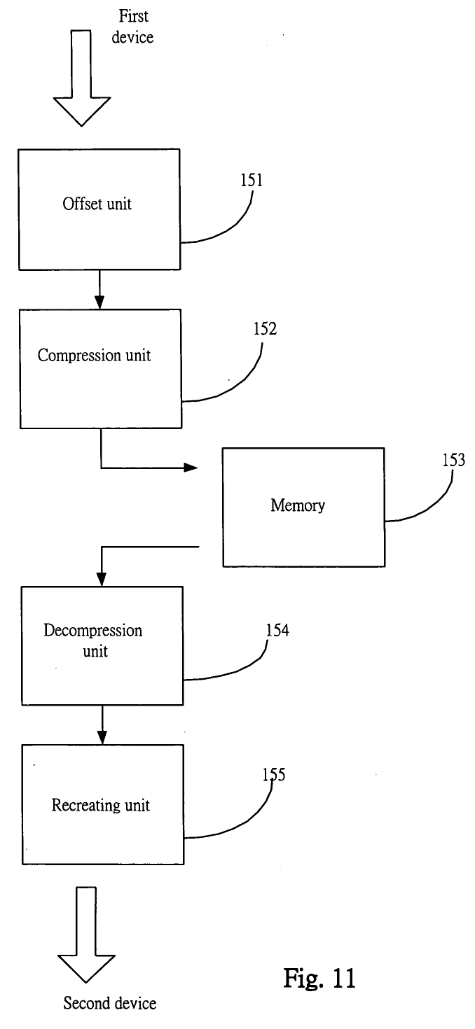

FIG. 11 illustrates a systematic diagram for implementing the CODECs 1201 and 118, which are connected between the first device and the second device. In the implementation, an offset unit 151 is used for calculating difference information in the image data received from the first device, e.g. the scaler 120 or the image processing unit 114. Examples of the difference information include the offset-planes and/or the adj-offset-values. The difference information is then applied in the compression unit 152, which performs a compression, e.g. the Golomb-Rice coding and/or the Huffman's coding. The compressed data are stored in a memory 153 temporarily. A decompression unit 154 decompresses the compressed data and a recreating unit 155 recreates image data based on the compressed data. Under loseless compression, the image data provided by the recreating unit 155 are identical to the image data received from the first device. However, under losssy compression, image data that are similar to the one received from the first device are recreated to the second device.

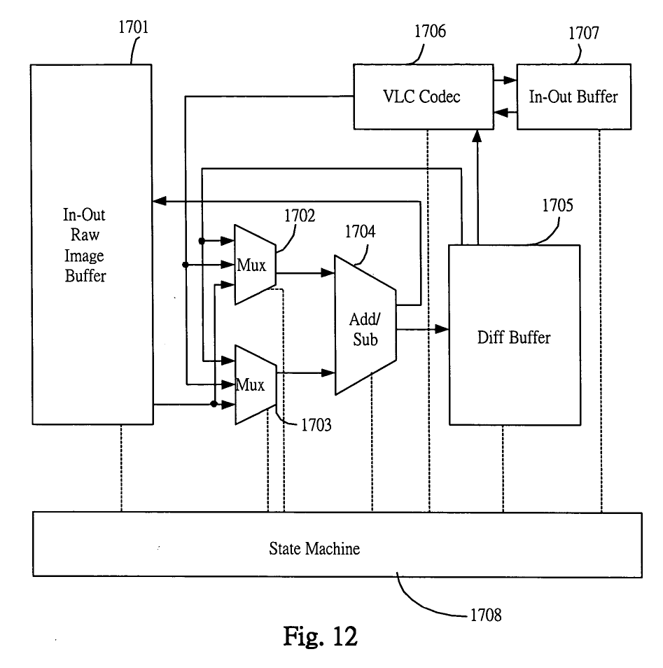

FIG. 12 illustrates a further detail example of implementing the example in FIG. 11. In-Out raw image buffer 1701 is used for receiving data from the first image device. During implementation, the In-Out raw image buffer 1701 does not need to store whole image data, but only need to store data necessary to be processed by calculating the difference information.

In the exampled disclosed above, difference information, like the offset-planes or the adj-offset-values, only needs operations of subtraction and/or addition provided by an addition/subtraction unit 1704, which inputs are controlled by a state machine via sending commands to multiplexers 1702, 1703. The difference information calculated by the addition/subtraction unit 1704 is stored in a DiffBuffer 1705 so that it can be used later by a VLC CODEC before storing in an In-Out buffer 1707.

When the second device is ready to process the image data, the compressed data stored in the In-Out buffer 1707 are decompressed by the VLC codec 1706 and recreated by the addition/subtraction unit 1704 controlled by the state machine 1708.

It is to be noted that persons skilled in the state machine art should be able to implement this example by reference to the descriptions and flow charts mentioned above. Also, a controller or any kind of logic circuit can be applied for performing the function and should be regarded within the scope of the present invention.

Particularly, it is not necessary to calculate one whole offset-plane before calculating adj-offset-values based on the offset-plane. Instead, the difference of the offset-plane and the adj-offset-values can be calculated block by block, serially or in parallel, which further decreases buffers necessary for performing the embodiment.

In other words, for saving the cost of the image buffer, the R, G, B or the Y, Cb, Cr planes don't need to be differentiated to be a complete offset-plane before going though further adjacent pixel subtraction.

Instead, the pixel of R, G, B or Y, Cb and Cr can be compressed pixel by pixel by subtracting the difference between color components while the adjacent pixels are subtracting. This kind of implementation saves image buffer of one to two picture frames. When mentioned the offset-plane in the description, it is easy and more feasible to use only a couple of pixels instead of a whole frame of picture as a unit of compression.

Which means, the difference among R, G, B or Y, U, and V can be taken to start the adjacent pixel subtraction and to go through other compression procedures to reduce the amount of image data. By using this means, a saving of a complete frame of image is obviously possible.

The R, G, B, the three color components can also be represented by Y, U, V, or Y, Cb, Cr, another popular representation of image pixel with Y representing the luminance of R-G-B, U,V are representation of relative color difference between Green to Blue and Green to Red. The Cb and Cr are the corresponding color components U and V with level shifting. In other words, the color planes mentioned above do not limit to R, G, B planes, but should include any color planes that can represent pixel information of images.

All above image compression techniques and procedures with R, G, B color components can also be represented by Y,U,V or Y, Cb, Cr and use similar compression techniques and procedures to compress the Y,U,V or Y, Cb, Cr as if the Y,U,V (or Y, Cb, Cr) are R,G,B color components.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method for temporarily buffering image data before the image data being transmitted from a first device to a second device, comprising:
receiving the image data from the first device, wherein the image data comprise raw pixel information;
compressing the image data into compressed data;
storing the compressed data in a memory; and
decompressing the compressed data for providing the decompressed data to the second device.

2. The method of claim 1, wherein the raw pixel information includes a plurality of color planes and the step of compressing the image data comprises:
calculating at least one offset-plane, wherein the at least one offset-plane comprises first difference information between two color planes; and
compressing the image data by referencing the at least one offset-plane instead of all the color planes.

3. The method of claim 2, wherein the step of compressing the image data further comprises:
calculating adjacent-offset-values of at least one color plane, wherein the adjacent-offset-values comprises second difference information among adjacent pixels of the at least one offset-plane; and
referencing the at least one offset-plane by utilizing the adjacent-offset-values instead of utilizing the offset-plane directly.

4. The method of claim 3, wherein the at least of offset-plane and the adjacent-offset-values are calculated block by block sequentially and repeatedly.

5. The method of claim 3, wherein the step of compressing the image data further comprises:
utilizing at least one variable length coding (VLC) to encode the adjacent-offset-values as the compressed data.

6. The method of claim 5, wherein a plurality of VLCs are separately utilized depending on the adjacent-offset-values.

7. The method of claim 6, wherein the plurality of VLCs comprises Huffman coding and Golomb-Rice coding, and the Huffman coding and the Golomb-Rice coding are selected based on which predetermined ranges the adjacent-offset-values are fallen in.

8. The method of claim 3, wherein a quantization operation is used for calculating the second difference information among adjacent pixels of the at least one offset-plane.

9. The method of claim 8, wherein the quantization operation is performed by a shift unit.

10. The method of claim 1, wherein the first device and the second device is communicated via a communication channel, and the step of compressing the image data and the step of decompressing the compressed data are performed in two ends of the communication channel.

11. The method of claim 1, wherein the first device is a scaler and the second device is an output device.

12. The method of claim 1, wherein the second device is a still image compression engine.

13. The method of claim 1, wherein the second device is motion picture compression engine.

14. The method of claim 1, wherein the raw pixel information includes a plurality of color planes and the step of compressing the image data comprises:
calculating adjacent-offset-values of at least one color plane, wherein the adjacent-offset-values comprises third difference information among adjacent pixels of the at least one color plane; and
compressing the image data by referencing the adjacent-offset-values instead of the at least one color plane directly.

15. The method of claim 14, wherein the step of compressing the image data further comprises:
calculating at least one offset-plane between two set of the adjacent-offset-values of two color planes, wherein the at least one offset-plane comprises fourth difference information between the two set of the adjacent-offset-values of the two color planes; and
referencing the two set of the adjacent-offset-values by utilizing the at least one offset-plane instead of utilizing the two set of the adjacent-offset-values directly.

16. A temporary buffer device for buffering image data before the image data are transmitted from a first device to a second device, comprising:
an offset unit for calculating difference information of the image data, wherein the image data comprises raw pixel information;
a compression unit for compressing the image data into compressed data by referencing to the difference information;
a memory for storing the compressed data;
a decompression unit for decompressing the compressed data; and
a recreating unit for providing recreated data to the second device.

17. The temporary buffer device of claim 16, wherein the raw pixel information comprises a plurality of color planes and the difference information that the offset unit calculates comprises at least one offset-plane.

18. The temporary buffer device of claim 17, wherein the difference information the offset unit calculates comprises adjacent-offset-values of the at least one offset-plane.

19. The temporary buffer device of claim 18, wherein the offset unit calculate the at least one offset-plane and the adjacent-offset-values block by block sequentially and repeatedly.

20. The temporary buffer device of claim 18, wherein the compression unit utilizes a plurality of VLC based on which predetermined ranges the adjacent-offset-values are fallen in.
